(19) United States
(12) Patent Application Publication
(10) Pub. No.: US 2021/0000251 A1
(43) Pub. Date: Jan. 7, 2021

(54) DECK CAPABLE OF BEING ASSEMBLED QUICKLY AND CONVENIENTLY

(71) Applicant: TSUNG CHIEH HUANG, Kaohsiung (TW)

(72) Inventor: TSUNG CHIEH HUANG, Kaohsiung (TW)

(21) Appl. No.: 17/029,078

(22) Filed: Sep. 23, 2020

Related U.S. Application Data
(63) Continuation of application No. 15/826,704, filed on Nov. 30, 2017, now abandoned.

(51) Int. Cl. A47B 13/00; F16B 12/10; A47B 13/06; F16B 12/14; A47B 41/00

(52) U.S. Cl. CPC A47B 13/003; F16B 12/10; A47B 13/06; A47B 2200/12; A47B 41/00; F16B 2012/106; A47B 2200/0085; F16B 12/14

(57) ABSTRACT

An deck capable of being assembled quickly and conveniently includes a desk frame formed by two rectangular frames; a rear upper bar being connected between two respective corners of two rectangular frames and a lower bar being connected between a middle section of front bars of two rectangular frames; each of two opposite inner lateral sides of the desk frame being formed with an insertion sheet, and two inner lateral sides of the two inclined sections of the two rectangular frames being formed with respective embedding sheets; a front stop plate being assembled to a front end of the desk plate; each of the two lateral sides of the desk plate being formed with a respective inward slot and each inward slot being further formed with an inner groove; in assembly, the two insertion sheets of desk frame will insert into the two inward slots of the desk plate for engagement.

The present invention is a continuation in part (CIP) of U.S. patent application Ser. No. 15/826,704, which is filed by the applicant of the present invention and therefore, contents of the U.S. patent application Ser. No. 15/826,704 is incorporated into the present invention as a part of the invention.

### FIELD OF THE INVENTION

The present invention relates to desks, and in particular to an deck capable of being assembled quickly and conveniently.

### BACKGROUND OF THE INVENTION

The learning desk is made mainly by using wood frames or metal frames to fix a desk plate and a receiving plate under the desk plate. As a result, the desk is lack of the function of free assembly and it is difficult to maintain the assembly elements and the function of updating. Furthermore colors of the desks are unique and thus it is not vivid in the teaching environment. Further it is not convenient, is difficult in assembly process. Furthermore the elements are not easily to change for assembly.

Therefore, there is an eager demand for a novel design which has the advantage of easily assembly, convenience in assembly, matching the requirement of ergonometrics, and easy maintenance. Furthermore the colors thereof are changeable easily and it is suidesk in teaching environments.

### SUMMARY OF THE INVENTION

The object of the present invention is to provide a deck capable of being assembled quickly and conveniently which can in the present invention, using the desk frame 1, desk plate 2 and front stop plate 3 to assembly a desk by the engaging ways and elements described above, the assembly of the desk become easy, convenient, quick, and ergonomically. Furthermore colors of the desk plate 2 and front stop plate 3 may be selected as desired so as to present a beautiful outlook.

To achieve above object, the present invention provides an deck capable of being assembled quickly and conveniently, comprising: a desk frame (1) formed by metal rods; the desk frame (1) being formed by two rectangular frames; a rear upper bar (1) being connected between two respective corners of two rectangular frames and a lower bar (15) being connected between a middle section of front bars (13) of two rectangular frames of the desk frame (1); an upper section of each front bar (13) being inclined inwards so as to form with an inclined section (12); each of two opposite inner lateral sides of the desk frame (1) being formed with an insertion sheet (11), and two inner lateral sides of the two inclined sections (12) of the two rectangular frames being formed with respective embedding sheets (14); a desk plate (2) being installed on an upper side of the desk frame (1); each of two opposite lateral sides of the desk plate (2) being formed with a slot (21) for engaging with the insertion sheet (11); a front stop plate (3) being assembled to a front end of the desk plate (2); each of the two lateral sides of the desk plate (2) being formed with a respective inward slot (20) and each inward slot (20) being further formed with an inner groove (21); in assembly, the two insertion sheets (11) of desk frame (1) will insert into the two inward slots (21) of the desk plate (2) for engagement.

### BRIEF DESCRIPTION OF THE DRAWINGS

FIG. 1 is an assembly about the assembly of the present invention.

FIG. 2 is an embodiment of the present invention.

FIG. 3 is a front view of the embodiment of the present invention.

FIG. 4 is a left side view of FIG. 3.

FIG. 5 is a right side view of FIG. 4.

FIG. 6 is a cross sectional view along line A-A of FIG. 1.

FIG. 7 is a cross sectional view along line B-B of FIG. 1.

FIG. 8 is a cross sectional view along line C-C of FIG. 1.

FIG. 9 shows the embodiment about the desk plate of the present invention.

FIG. 10 is right side view of FIG. 9.

FIG. 11 is a left side view of FIG. 10.

FIG. 12 is a right side view of FIG. 10.

FIG. 13 shows an embodiment about the front stop plate of the present invention.

FIG. 14 is an elevational view of FIG. 13.

FIG. 15 is a left side view of FIG. 13.

FIG. 16 is a right side view of FIG. 13.

FIG. 17 is an assemble schematic view about the hooking seat and the hook of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

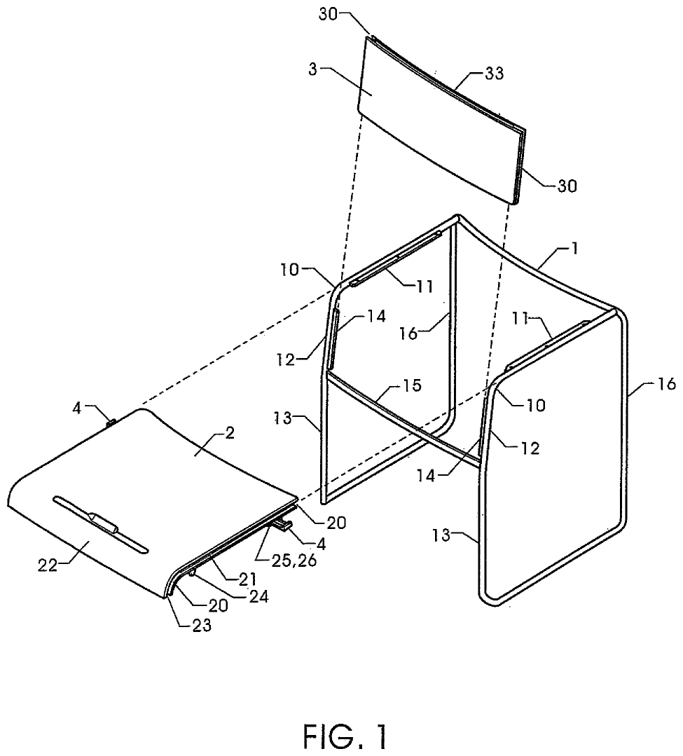

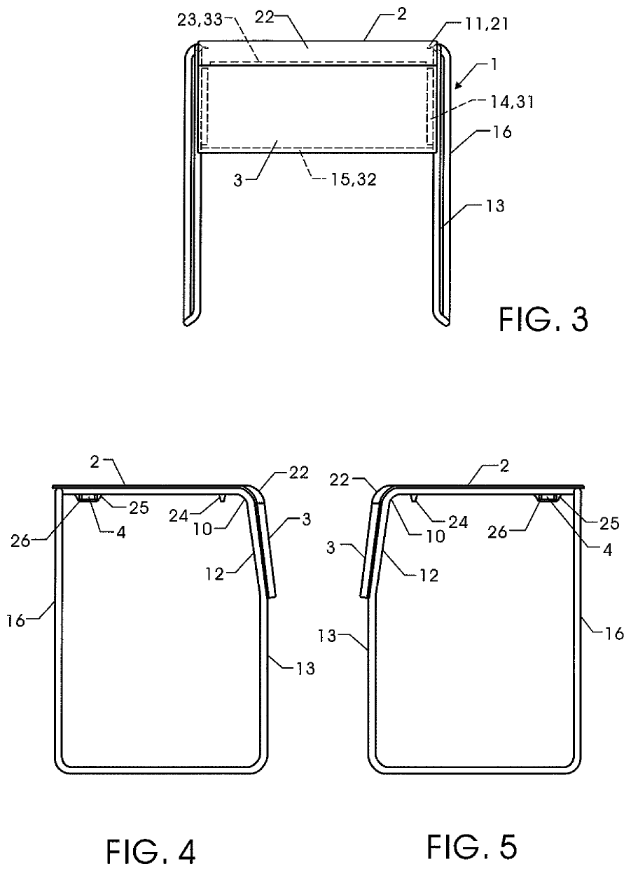

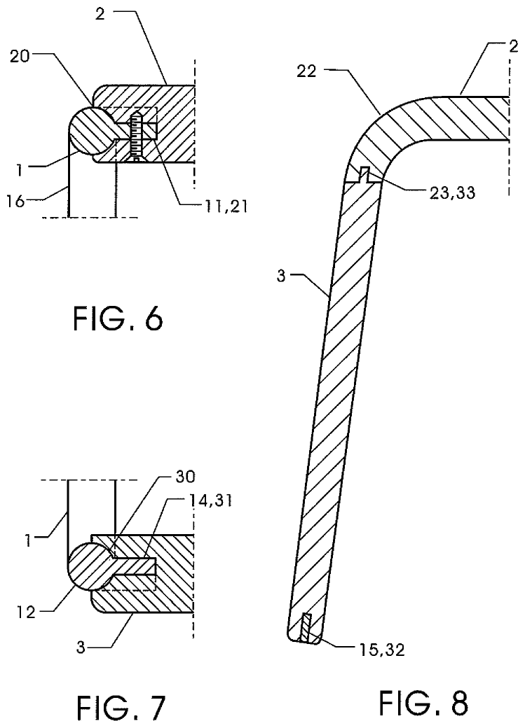

A desk includes the following elements, as shown in FIGS. 1 to 8.

A desk frame 1 formed by metal rods. The desk frame 1 is formed by two rectangular frames. A rear upper bar 1 is connected between two respective corners of two rectangular frames and a lower bar 15 is connected between a middle section of front bars 13 of two rectangular frames of the desk frame 1. An upper section of each front bar 13 is slightly inclined inwards so as to form with an inclined section 12. Each of two opposite inner lateral sides of the desk frame 1 is formed with an insertion sheet 11, and two inner lateral sides of the two inclined sections 12 of the two rectangular frames are formed with respective embedding sheets 14. A gap between the two front bars 13 is smaller than that of two rear bars 16 of the two rectangular frames.

A desk plate 2 is installed on an upper side of the desk frame 1; each of two opposite lateral sides of the desk plate 2 is formed with a slot 21 for engaging with the insertion sheet 11.

A front stop plate 3 is assembled to a front end of the desk plate 2.

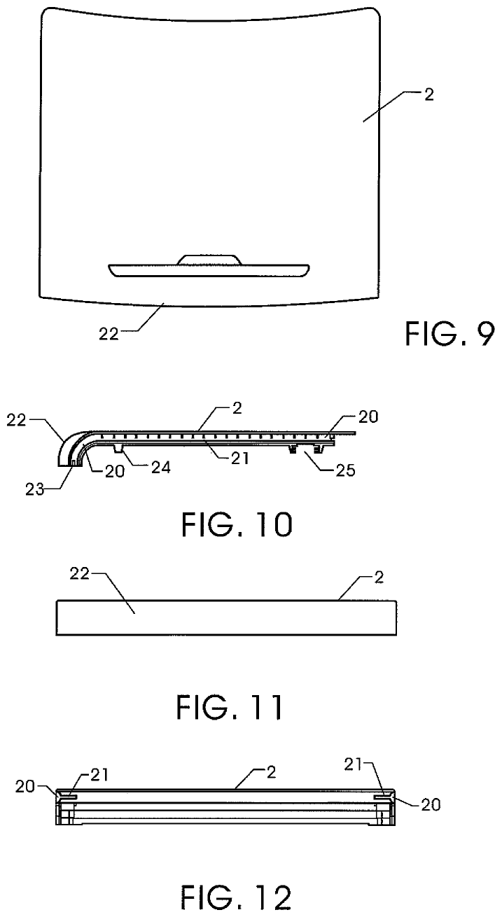

Referring to FIGS. 9 to 12, it is shown that a front side of the desk plate 10 is curved downwards to form as a curved downward section 22.

Each of the two lateral sides of the desk plate 2 is formed with a respective inward slot 20 and each inward slot 20 is further formed with an inner groove 21. In assembly, the two insertion sheets 11 of desk frame 1 will insert into the two inward slots 21 of the desk plate 2 for engagement. After engagement, a screw is inserted into a bottom side of the desk plate 2 and passes through the insertion sheet 11 of the desk plate 2 so as to fix the insertion sheet 11 of the desk plate 2.

With reference to FIGS. 9 to 12, each of the two lateral sides of the front stop plate 3 is formed with a respective inward slot 30 and each inward slot 30 of the front stop plate 3 is further formed with an inner groove 31. In assembly, the two embedding sheets 14 of desk frame 1 will insert into the two inward slots 31 of the front stop plate 3 for engagement.

A front lower side of the curved downward section 22 of the desk plate 2 is formed with a transversal slot 23 and an upper lateral side of the front stop plate 3 is formed with a transversal flange 33. The transversal slot 23 of the desk plate 2 will receive the transversal flange 33 of the front stop plate 3 so as to engage the desk plate 2 with the front stop plate 3.

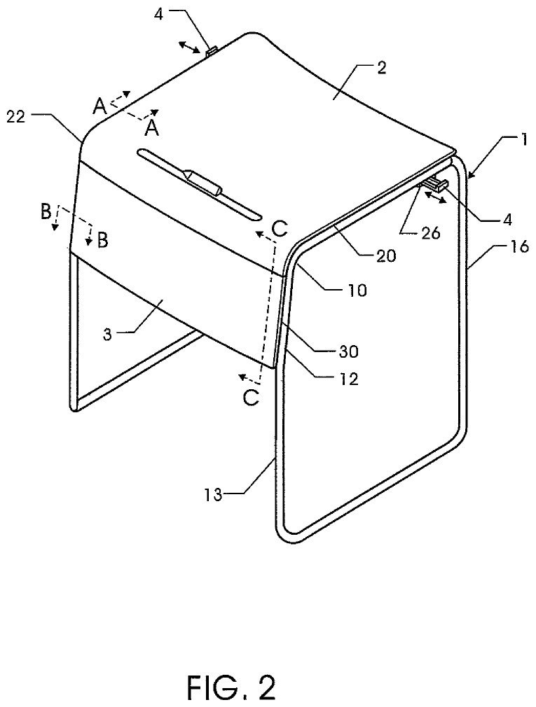

With reference to FIG. 2, two lateral sides of the desk plate 2 are extended with respective balance blocks 24 so that when multiple desks are stacked one by one, the balance block 24 may have the effect of balance.

Each of two lower lateral edges is installed with a hooking seat 26 and each hooking seat 26 is installed with a slidable hook 4. A lower side of the desk plate 2 is formed with an assembly groove 25 for engaging two claws at two sides of the hooking seat 26.

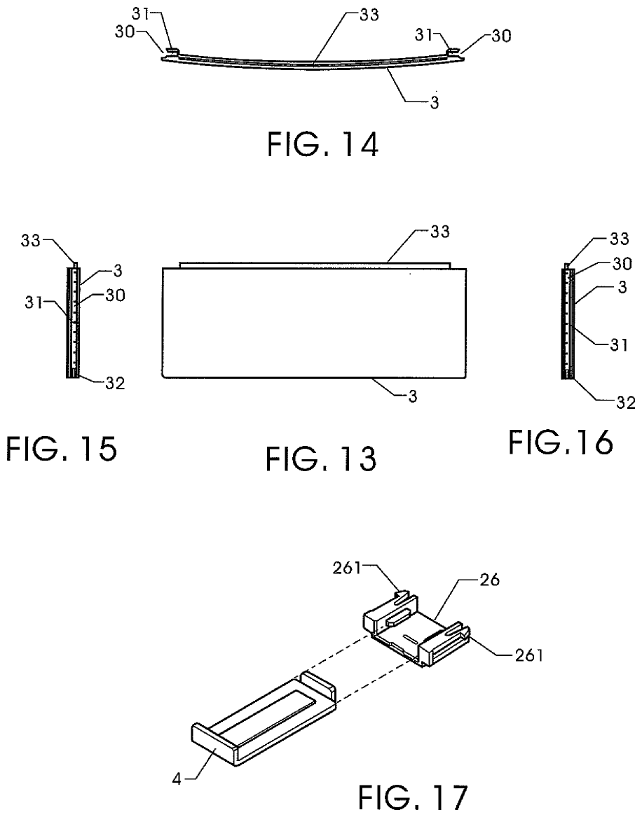

As illustrated in FIGS. 13 to 16, a front lower bottom of the front stop plate 3 is formed with embedding slot 32 for receiving the lower bar 15 of the desk frame 1.

Referring to FIGS. 1 and 6 to 8, in the present invention, using the desk frame 1, desk plate 2 and front stop plate 3 to assembly a desk by the engaging ways and elements described above, the assembly of the desk become easy, convenient, quick, and ergonomically. Furthermore colors of the desk plate 2 and front stop plate 3 may be selected as desired so as to present a beautiful outlook.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A deck capable of being assembled quickly and conveniently, comprising:
the desk frame (1) being metal rods and formed by two rectangular frames; a rear upper bar (1) being connected between two respective corners of two rectangular frames and a lower bar (15) being connected between a middle section of front bars (13) of two rectangular frames of the desk frame (1); an upper section of each front bar (13) being inclined inwards so as to form with an inclined section (12); each of two opposite inner lateral sides of the desk frame (1) being formed with an insertion sheet (11), and two inner lateral sides of the two inclined sections (12) of the two rectangular frames being formed with respective embedding sheets (14);
a desk plate (2) being installed on an upper side of the desk frame (1); each of two opposite lateral sides of the desk plate (2) being formed with a slot (21) for engaging with the insertion sheet (11); and
a front stop plate (3) being assembled to a front end of the desk plate (2); each of the two lateral sides of the desk plate (2) being formed with a respective inward slot (20) and each inward slot (20) being further formed with an inner groove (21); in assembly, the two insertion sheets (11) of desk frame (1) will insert into the two inward slots (21) of the desk plate (2) for engagement.

2. The deck capable of being assembled quickly and conveniently as claimed in claim 1, wherein each of the two lateral sides of the front stop plate (3) is formed with a respective inward slot (30) and each inward slot (30) of the front stop plate (3) is further formed with an inner groove (31); in assembly, the two embedding sheets (14) of desk frame (1) will insert into the two inward slots (31) of the front stop plate 3 for engagement.

3. The deck capable of being assembled quickly and conveniently as claimed in claim 1, wherein a front lower side of the curved downward section (22) of the desk plate (2) is formed with a transversal slot (23) and an upper lateral side of the front stop plate (3) is formed with a transversal flange (33); the transversal slot (23) of the desk plate (2) will receive the transversal flange (33) of the front stop plate (3) so as to engage the desk plate (2) with the front stop plate (3).

4. The deck capable of being assembled quickly and conveniently as claimed in claim 1, wherein after engagement of the desk frame (1) to the desk plate (2), a screw being inserted into a bottom side of the desk plate (2) and passes through the insertion sheet (11) of the desk plate (2) so as to fix the insertion sheet (11) of the desk plate (2);

5. The deck capable of being assembled quickly and conveniently as claimed in claim 1, wherein two lateral sides of the desk plate (2) are extended with respective balance blocks (24) so that when multiple desks are stacked one by one, the balance block (24) has the effect of balance; and each of two lower lateral edges is installed with a hooking seat (26) and each hooking seat (26) is installed with a slidable hook (4); a lower side of the desk plate (2) is formed with an assembly groove (25) for engaging two claws at two sides of the hooking seat (26).

6. The deck capable of being assembled quickly and conveniently as claimed in claim 1, wherein a front side of the desk plate (10) is curved downwards to form as a curved downward section (22).
